(19) United States
(12) Patent Application Publication
(10) Pub. No.: US 2015/0262098 A1
(43) Pub. Date: Sep. 17, 2015

(54) UNIFIED DIGITIZATION OF COMPANY ESSENTIALS WITH REMOTE ACCESSIBILITY

(71) Applicant: Curtis Kinsey, Allendale, MI (US)

(72) Inventor: Curtis Kinsey, Allendale, MI (US)

(21) Appl. No.: 14/444,522

(22) Filed: Jul. 28, 2014

Related U.S. Application Data
(63) Continuation of application No. 14/217,151, filed on Mar. 17, 2014.

(51) Int. Cl. G06Q 10/06

(52) U.S. Cl. CPC G06Q 10/0639

(57) ABSTRACT

The present invention is a system that is an online company portal for includes, but is not limited to the following, managing, recording information, prepare reports, prompt sales associates to offer sales to customer, accounting, operations, and sales processes. It may be 100% permission based and remotely securely accessible online via just about any web browser and mobile device.

### PRIORITY AND PRIOR APPLICATIONS

This non-provisional patent application is a continuation in part that claims priority from a non-provisional patent application filed on 17 Mar. 2014 with application Ser. No. 14/217,151, which claims priority to the filing of a provisional patent application filed on 16 Mar. 2013 with application No. 61/802,631.

### FIELD OF THE INVENTION

This invention relates to a Remotely Accessible Permission-Based Employee and Store Management Tracker system, apparatus, and method.

### BACKGROUND OF THE INVENTION

Companies, schools, and people in leadership roles prefer to explore ways to increase employee or student performance, customer satisfaction, address customer needs, and keep employees productive and satisfied with their work.

In addition, companies and other entities may attempt to employ methods to collect and analyze customer satisfaction metrics, in order to determine if current marketing and customer service methods and programs are effective.

Employers may typically attempt to connect all feedback in real time, and then generate an output to employee, store, or service reviews.

Managers of employees have a need to timely receive information and feedback on employee procedures and goals, and whether correct procedures are followed and whether the goals have been reached.

There exists a need for a method to track performance of employees and allow the employee to view their performance.

Multiple embodiments of the system are disclosed herein. It will be understood that other objects and purposes of the invention, and variations thereof, will be apparent upon reading the following specification and inspecting the accompanying drawings.

These and other features, aspects, and advantages of the present invention will become better understood with reference to the following drawings, description, and claims.

### SUMMARY OF THE INVENTION

One aspect of the present invention is a unified digitization of company essentials with remote accessibility system, comprising: a plurality of modules; said module operable with a database having customer information and store information; said module is customizable and said module is operable with said database by a set of parameters that are defined from within an administrator control panel of the system; said parameters allow the system to read from and write to said database; said modules can be selected to launch a certain portal including at least one of the following; an admin control panel, user control panel, reports and trends window, customer capture window, and a customer interaction window; and at least one of said modules that launches a window that prompts the user to qualify a client or customer information; said window has an icons, have different colors as indicators as to whether the user is supposed to offer a specific good or service to the customer.

Another aspect of the present invention is a method of using a unified digitization of company essentials with remote accessibility interface, comprising the steps: logging in; creating a module; linking said module with a database by using a set of parameters that are defined from within an administrator control panel of the system; reading and writing data between a database and a module; and selecting a module that has been operably connected to a database.

A third aspect of the present invention is a unified digitization of company essentials with remote accessibility system, comprising a module; said module operable with a database having at least one of either customer information or store information.

A fourth aspect of the present invention is a method of making a unified digitization of company essentials with remote accessibility 1000, comprising the steps of: making a module 60 that can display customer information 1010; entering metrics 1020, such as customer name, phone number, and email address, or whichever metrics the company deems most relevant to their particular industry; some customer information 430, called “top fields, such as phone number, customer name, and/or email address will auto-populate the entire window and give search options in a secondary drop-down menu available by pressing an icon 250, such as a magnifying glass icon;

auto-populating 1030 performed by the system pulling information from existing company databases made possible by the system executing code that searches and retrieves customer information based upon the field typed in, for example, the user or employee types customer phone number, either full or partial, the system does a search for said number and displays immediately the results found thus far, in a manner similar to a Google® search, in a drop down with pertaining information with partial or full results; If a partial or full result is selected from the drop down menu the system then retrieves from the pertinent customer database, displays, and populates all customer information in the program fields 790; this enables easy auto-completion for return customers; obviously, this will not work for completely new customers that have not been to any company locations whatsoever; the data 90 must already exist within one of the company databases; It will exist after submission of the current customer if this is the case;

recording 1040 of whether permission has been given to use the telephone as a valid means of contacting the individual customer on the current account; and recording of the address as well as for the tracking of most popular areas, and for the mailing of packages, mailers; another icon, may allow for integration with any map engine to show the exact street location of the customer's residence or place of business;

integrating the map 1050 by defining parameters 900 within the administrator control panel 40; this is done by providing a pre-defined link 820 such as a link to Google Maps®, or similarly predefined link 820 that is ready for the insertion of an address, such as a customer 300 address; the system executes code upon retrieving customer address that converts an icon 250, such as the globe icon, into this predefined digital map link, containing the customer address. When this predefined map link (820) with customers address is selected, a digital map will appear, pinpointing the customers address; this is all performed and executed via written code;

creating custom fields 1060 through the admin control panel 40; said admin control panel 40 may allow the user to add or remove custom fields by clicking or activating the add (+) and remove (−) buttons located next to the custom fields;

selecting a visit summary field 1070, which will, once selected, expand to a larger text field allowing for the custom entry of a summary of the visit including whatever has been deemed essential by the company. Upon submission of the current customer interaction, the visit summary along with all other fields 790 and information will be compiled and available for distribution within the company;

expanding the visit summary 1080 by an allowance in the code for the text box to auto-expand or auto-resize when the text entered exceeds the current view; for example, one line becomes two, two becomes three, three becomes four, etc. . . . and this can occur up to a predefined amount and size defined within the admin control panel 940;

compiling 1090 is performed by, the system 10 writing all collected data 90 to all pertinent databases 20 of the company, which makes this data 90 and all changes reflect immediately company-wide; all database parameters 50, such as location of, are defined in the admin control panel 40; for example, upon submission of the current customer, all customer data 90 will submit and save-to the existing company “customer information” database, which is selected within admin control pane 40 prior to the present invention 10 running in a company;

populating by the system 1100, pulling information from existing company database(s), this is made possible by the system executing code that searches and retrieves customer information based upon the field 790 typed in; for example, the user or employee types customer phone number, either full or partial, the system does a search for said number and displays immediately the results found thus far, in a manner similar to a Google® search, in a drop down with pertaining information with partial or full results; If a partial or full result is selected from the drop 880 menu, the system then retrieves from the pertinent customer database 20, displays, and populates all customer information in the program fields 790; this enables easy auto-completion for return customers; obviously, this will not work for completely new customers that have not been to any company locations whatsoever; the data 20 must already exist within one of the company databases 90; It will exist after submission of the current customer if this is the case;

integrating the present invention to the company database 1110 with full auto-completion of all information; the customer capture window 180 may always be open and running and is fully configurable through the admin control panel 40; full import and export capability for reports, database compiling 850 and history viewing; automation of said tasks is also available and can be performed on an interval schedule; the present invention is available cross-platform due to its secure web-based nature, and is always accessible via anything that is capable of running a web-browser; all actions and abilities of the present invention are permission based as set by the admin control panel 40; in the top right corner of the one of the windows or interface 500 may be information on the current user; the user may have an avatar or picture or icon 250 appear as well as the name of the user, their employee id, store location, or other pertinent information; all of which is dynamically imported from the admin and user control panels 310; and

activating at least one of either a button or icon to open up the full point of sale module 1120 also referred to as a point of sale window 810 with all the advanced options, will fill the window and anything relevant to point of sale will be shown here; said point of sale module 810 It can replaces the previously used condensed version of point of sale module 810, and any already entered information will be carried over to the new point of sale module 810 interaction display, this is done seamlessly, non-intrusively, and fluidly; this is performed by the system reading from all existing fields and utilizing this information within and throughout the point of sale module; additionally, this information may be retrieved from existing database(s) in real-time and to ensure accuracy.

### BRIEF DESCRIPTION OF THE DRAWINGS

FIG. 1 illustrates an embodiment of an admin control window;

FIG. 2 illustrates and embodiment of a user control panel;

FIG. 3 illustrates a reports and trends window;

FIG. 4 illustrates a captured customer window;

FIG. 5 illustrates a customer interaction window;

FIG. 6 illustrates an embodiment of a specific customer window;

FIG. 7 illustrates an embodiment of the steps involved in using the invention; and

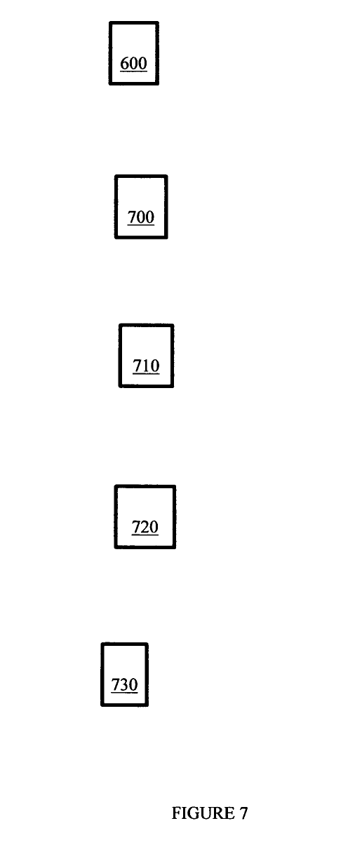

FIG. 8 illustrates an embodiment of the method of using the present invention.

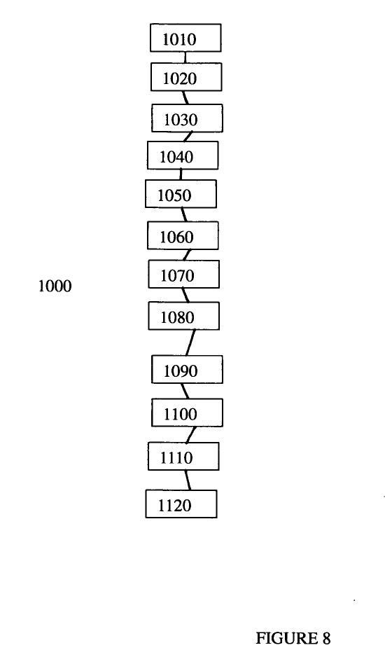

### DETAILED DESCRIPTION OF THE INVENTION

### Reference Numerals

10 system or present invention or Unified Digitization of Company Essentials with Remote Accessibility
20 database
30 interactive device
40 administrative control panel, admin control panel, or administrator control panel
50 parameter
60 module
70 another program
80 reports
90 data
100 general settings
110 custom settings or custom field
120 report setting
130 custom module settings
140 portal
150 costumer contact information
160 visit reason
170 interact summary
180 customer capture window or captured customer window
190 contact module
200 service reminder module
210 personal module
220 location module
230 company module
240 customer interaction window or customer module
250 icon or bags or images
260 company reports
270 employee reports
280 product reports
290 location reports
300 customer
310 user control panel window or user control panel
320 general settings
330 report settings
340 customer settings
350 custom module settings
370 global module
380 user and location module
390 notifying salesperson
400 product module
410 marketing module
420 report module
430 customer information
440 store information
500 interface or window
510 offering a product or service
600 logging in
700 selecting a module
710 entering metrics
720 map integration
730 account pass code
740 visit reason portion
760 visit summary
770 compilation
780 expansion
790 field
800 list
810 point of sale module
820 pre-defined link
830 pre-defining all parameters and settings
840 risk identifier
850 database compiling
860 activating an icon
870 add and remove buttons
880 drop down menu
890 lists-rows
900 defining parameters
910 linking said module
920 creating a module
930 autopopulating
940 displaying information
950 alerting or notifying
960 file or computer program
970 creating a file
980 step of all changes instantly live
990 programming the system for unlimited capabilities of use m
1000 method of performing the present inventions
1010 making

The following detailed description is of the best currently contemplated modes of carrying out the invention. The description is not to be taken in a limiting sense, but is made merely for illustrating the general principles of the invention, since the scope of the invention is best defined by the appended claims.

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

The present invention may be a system that is an online company portal intended and projected to replace just about everything you can think of from accounting, operations, sales processes, etc. It may be 100% permission or title based and thus have access restriction and remotely securely accessible online via just about any web browser and mobile device, such as a phone, tablet, or computer, also referred to as an interactive device 30.

The system is unique in many aspects, but helps keep employees, stores, and all information unified into a single place and log-in.

Base purpose of the present invention 10 may be to unify and keep linked or updated throughout all systems employees and stores and their information, which also improves accountability.

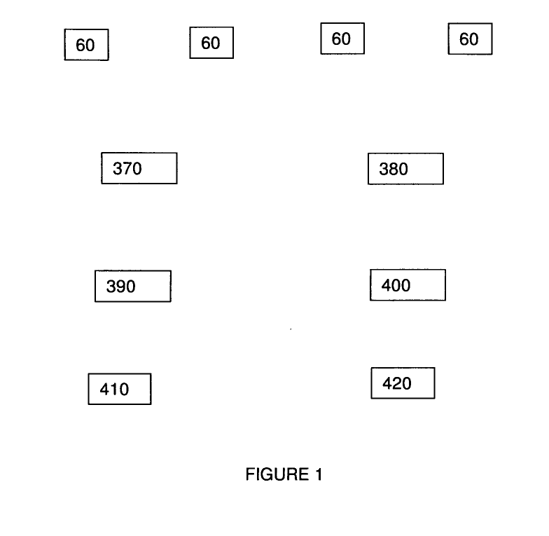

In one embodiment, modules 60 may be disposed along the top of the screen, as seen in FIG. 1. The module 60 can be selected to launch a certain portal 140. A portal 140 includes an admin control panel 40, user control panel 310, reports and trends window 450, customer capture window 180, or a customer interaction window 240.

The modules 60 can be modified by a user based on permission settings. For example, the administrator may be the only user authorized to add or modify modules 60.

A module 60 can be used to interface with the user. Modules 60 may be added, deleted, and modified, thereby making the module 10 customizable.

A module 60 may be operable with a database 20. For example, the present invention 10 can read and write to a RQ4 database. The company or user or administrator can define all products and services in such a database 20. This means that if a user activates a module 60 by, for example, clicking it on a tablet, phone, or with a computer mouse, the selected module 10 can pull data from any existing database 20 or another program 70. Thus, anyone using the system 10 does not have to replace any other program. There may be more than one database 20, and it is expected that many databases 20 would be used with the present invention 10. One database 20 customer information 430, while another database may have store information 440, or information about the company such as employees and different store locations.

The present invention 10 is thus ready to adopt any function of a business as a module 60 or portal 140. For example, someone can replace a point of sale program and add it as a module 60 or portal 140.

The present invention 10 is made operable with a database 20 by a set of parameters 50 that is defined from within an administrator control panel 40 of the system 10; said parameters 50 allow the system 10 to read from and write to said database 20.

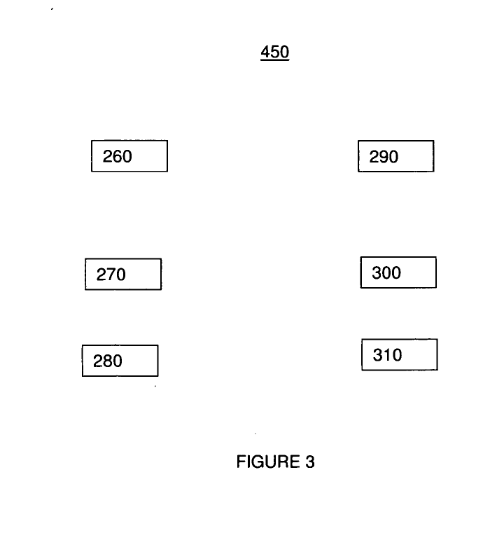

As seen in FIG. 3, one module 60 may be selected to access and launch a reports and trends portal 450. This may contain information regarding trends and reports, such as company reports, such as company performance, sales, trend, and grade. The user can set the system to automatically send custom company reports 260 through e-mail and messaging on a defined periodic schedule, including raw data, images, and graphs.

The same or a different module 60, depending on administrator preference may access location reports, such as location performance, sales, trend, and grade. The user can set the system to automatically send custom company reports 260 through e-mail and messaging on a defined periodic schedule, including raw data, images, and graphs.

There may be a plurality of modules 10. In one embodiment, the modules 10 may be disposed horizontally along the top of a website.

In one embodiment, an administrator or other with proper rank may also be assigned via an administrator control panel 40, and can on-the-fly add, remove, modify anything, including: modules, users, customers, and products from directly within the relevant windows of the present invention 10.

Additionally, the present invention 10 may be designed as such that anything and everything can be achieved through a simple drag n drop, or point and click, interface 500 from within the master admin control panel 40. This includes everything from add, create, delete, modify, to automation. Automation may include but not be limited to auto reports on intervals, auto text/email, etc.

During the modification or creation process of a module 60, the appearance of certain links, features, and functions are set per user or group. For example all employees can generate a self-grading sales report from within a user control panel 310. This is the same for anything and everything. Where these “links” to said functions appear is completely up to the user or owner or company, thus completely customizable, for example, one company may not have a user control panel. The user includes the owner and company.

The user may control settings to have the present invention send hourly automated reports of location and employee grades.

Another embodiment of the present invention 10 may allow a user to add the ability to run a point of sale as a module within the present invention 10.

The present invention 10 may have complete integration with the user's databases 20 and other complete integration meaning that a user can directly read/import from all existing database(s) 20 and data 90. For example, the user may pull their existing customers from a point A in the database 20, their existing products from point B in the database 20, and their employees from point C in the database 20. All data 90 will then be fed and imported into the present invention 10 seamlessly and ready to use.

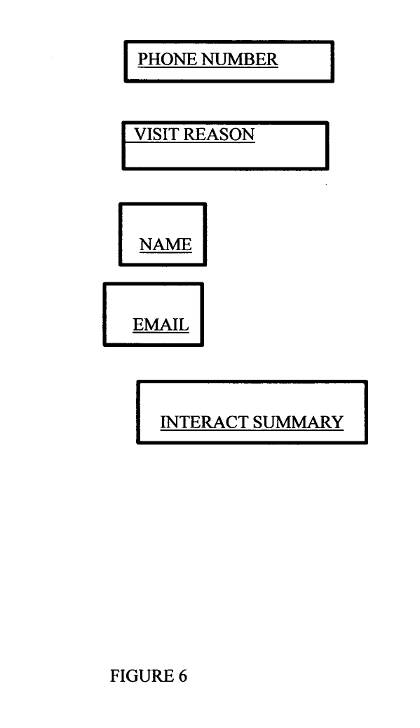

Customer information and data 90 may be entered in a portal 140, interface 500, or website as illustrated in FIG. 6. This portal 140 may have customer name and customer contact information 150, visit reason 160, and interact summary 170. This portal 140 may have other prompts to illustrate what products or services were offered, which products or services were sold, and other information.

Another portal 140 may be an end of the day checklist so the employee would review before leaving work (not illustrated).

Another portal 140 may be a live scoreboard showing company numbers for a certain time.

Per above example, the constant and automated pulling and importing of said data 90 can be defined. This would permit a user or user's employer to continue using existing systems and programs with the present invention 10.

The present invention 10 may be built for the unlimited addition of functions and features defined as modules 60 that launch portals 140 or windows 140. The portals 140 may have links a data 90 stored on a database 20. This means that the present invention 10 can handle for example product ordering, point of sale (checkout), and anything else the company desires. These features are not required, but optional. Some companies may not like the idea of replacing entire systems.

Clicking another module 60 may launch an admin control panel 40 or window 500, which may also be referred to as an interface 500, as seen in FIG. 1. The admin control window 40 may have a global module 370, user location module 380, customer module 240, product module 400, marketing module 410, and a report module 420.

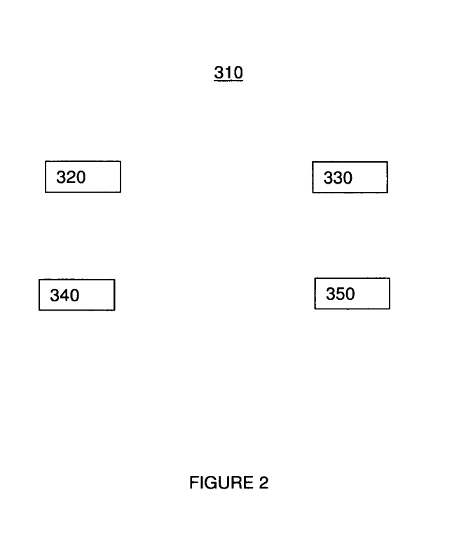

Clicking another module 60 may launch a user control panel window 310 as illustrated in FIG. 2. The user control panel window 310 may have a general settings 320, report settings 330, customer settings 340, and custom module settings 350.

The report settings 330 allow a user the capability to schedule automated reports and these reports can be emailed to a predetermined set of contacts or addresses.

The general settings 320 may include the user information, the store information, time and date format, and themes.

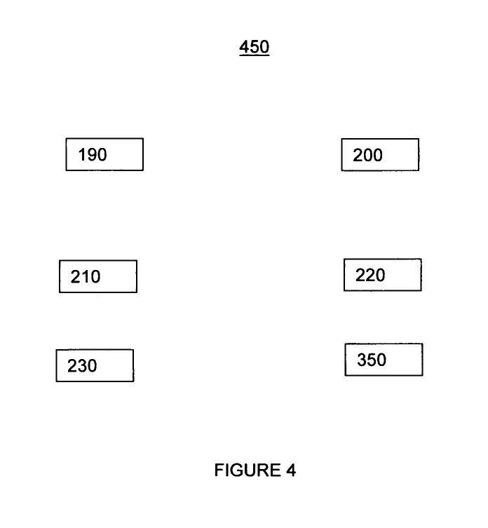

As seen in FIG. 4, clicking another module 60 can open up a captured customer window 180, having a contact list module 190, service reminder module 200, a personal module 210 to manage user specific customer access and management, to allow the user to access lists, managing user notes, orders, requests, and to execute automated or non-automated customer specific tasks.

This captured customer window 180 may also have a location module 220. This location module 220 may have location specific customer, store, or employer information. For example, if a company had several different locations, the location module 220 would be used to find information on different store locations.

This captured customer window 180 may also have a company module 230, which provide the user to company wide information.

Depending on the type of company, a custom module 350 could be added.

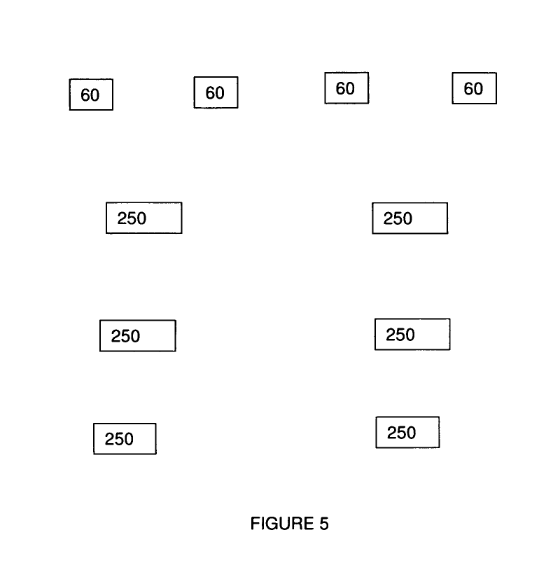

FIG. 5 illustrates a customer interaction window 240. This specific customer interaction window 240 has costumer information such as name and contact information, and icons 250 such as bags 250 that may prompt the user to offer products or services to the customer. The icons 250 may have different colors as indicators. For example, a red icon 250 may indicate that a certain product was offered and rejected; a green icon 250 may indicate that a product was offered and sold; a yellow indicator would indicate that a product is recommended for the customer, prompting the user to offer that service to the customer.

One module may prompt the use to qualify a client or customer. The system 10 may prompt the user with certain questions to ask the customer, such as, offering a product or service 510, and then the user can enter information such as (1) whether the product of service was offered by the user to the customer; (2) if the customer purchased the product or service, or (3) if the customer declined the product or service; and any other relevant information. All of this data 90 would be recorded and stored. The next time that the user would engage with the customer, all of this data 90 is available for the user to see or otherwise access. A blind user would also have access through either audio or brail.

Regardless the route chosen by the company, complete, seamless, and most importantly, automated integration of any and all data 90 and databases 20 is guaranteed here.

The present invention 10 will allow employees to enforce accountability, and does not add time to record or use the data 90.

The present invention 10 can replace a point of sale system or a customer management relationship (CRM) program.

One module 60 can display customer information. In one embodiment, this can be called the customer interaction window 240. For a returning customer, the customer begins interaction with employee; and said employee will begin by entering metrics 710, such as customer name, phone number, and email address, or whichever metrics the company deems most relevant to their particular industry. Some customer information 430, which may be referred to as “top fields, such as phone number, customer name, and/or email address will auto-populate the entire window and give search options in a secondary drop-down menu available by pressing an icon 250, such as the magnifying glass icon.

This auto-population is performed by the system, pulling information from existing company database(s), this is made possible by the system executing code that silently searches and retrieves customer information based upon the field typed in. For example, the user or employee types customer phone number, either full or partial, the system does a search for said number and displays immediately the results found thus far, in a manner similar to a Google® search, in a drop down with pertaining information with partial or full results. If a partial or full result is selected from the drop down menu 880, the system then retrieves from the pertinent customer database 20, displays, and populates all customer information in the program fields 790. This enables easy auto-completion for return customers. Obviously, this will not work for completely new customers that have not been to any company locations whatsoever. The data 90 must already exist within one of the company databases 20. It will exist after submission of the current customer if this is the case.

For new customers, after the web application 10 program 10 is opened, new customer data 90 can be entered with by opening the customer interaction window 240.

Icons 250 can appear on the customer interaction window 240 or customer module 240 to alert 950 or notifying 950 the salesperson to offer sales suggestions to the customer.

An icon 250, such as a phone icon 250 allows for the recording of whether permission has been given to use the telephone as a valid means of contacting the individual customer on the current account. Mailing address allows for the recording of the address as well as for the tracking of most popular areas, and for the mailing of packages, mailers, et cetera. Another icon 250, such as a globe icon may be positioned next to the address field 790 and may allow for integration with Google Maps, or whichever maps engine the user prefers, to show the exact street location of the customer's residence or place of business.

This map integration 720 is performed by defining parameters 900 within the administrator control panel 40. This is done by providing a pre-defined link 820 such as a link to Google Maps®, or similarly predefined link 820 that is ready for the insertion of an address, such as a customer 300 address. The system 10 executes code upon retrieving customer address that converts an icon 250, such as the globe icon, into this predefined digital map link 820, containing the customer address. When this predefined map link 820 with customers address is selected, a digital map will appear, pinpointing the customers address. This is all performed and executed via written code. Here is an example of what this link would look like: (https://maps.google.com/maps?q=map+of+Angel%27s+Thai+Cafe) Clicking this link will open a direct Google map pinpointing Angels Thai Cafe. The same can occur with MapQuest, Yahoo, Bing, and any others. They have designed this intentionally.

The present invention 10 may require an account pass code to allow for the secure at-home access of the account and later updating or changing of information. The interface 500 may have a visit reason portion 740. Activating the visit reason portion 740 may open a drop-down menu listing valid reasons for the customers visit to the location, if the reason for some reason is not available the an ‘other’ option is available and will prompt the user to type in a custom reason.

An infinite number of custom fields 750 may be created by adding the desired custom fields 110 through the admin control panel 40, and on the back-end programming 730 the custom fields 110 or custom setting 110 to perform the step of interacting with the database 740 in a desired manner, i.e. autofill, saving, creating data 90. These custom fields 110 will then be treated identical to other custom fields 110 or custom settings 110, such as customer name, e-mail address, etc. but with pre-defined special function, if other than a simple text field 790, such as a drop-down 880, action on click.

The custom fields 110 may be available, accessed, or created through the admin control panel 40. The admin control panel 40 may allow the user to add or remove custom fields by clicking or activating the add (+) and remove (−) buttons located next to the custom fields.

In one embodiment may be a visit summary field 760, which will, once selected, expand to a larger text field allowing for the custom entry of a summary of the visit including whatever has been deemed essential by the company. Upon submission of the current customer interaction, the visit summary along with all other fields 790 and information will be compiled and available for distribution within the company.

The expansion 780 of the visit summary is performed by an allowance in the code for the text box to auto-expand or auto-resize when the text entered exceeds the current view. For example, one line becomes two, two becomes three, three becomes four, etc. . . . . This can occur up to a predefined amount and size defined within the admin control panel 40.

The compilation 770 is performed by, the system 10 writing all collected data 90 to all pertinent database(s) 20 of the company, which makes this data 90 and all changes reflect immediately company-wide. All database parameters 50, such as location of, are defined in the admin control panel 40. For example, upon submission of the current customer, all customer data 90 will submit and save-to the existing company “customer information” database, which is selected within admin control pane 40 prior to the present invention 10 running in a company.

There may be large open text fields 790, one to the left, and one to the right, which allow for the custom input of lists 800 by the user, who would normally be a corporate entity such as a company. The number of these can be changed based on the company's desires The open text fields 790 may be “lists/rows” of data 90 that may be selected and then show more information via a popup/window expansion within The present invention 10. Example: (left box displays: row 1, row 2, row 3, and so on of all owned and recommended products. Right box displays: row 1, row 2, row 3, and so on of all customer history (purchases, service changes, store visits, etc.), each new item taking one entire “line/row.” Clicking one of these “rows or lines” will expand a window within the present invention 10, displaying full detail of the selected item.

For example, the left field 790 will change based on system populated ‘needs’ and currently owned products or subscribed services. This list 800 will dynamically change and will be fully configurable through the admin control panel 40. Images and icons 250 can be integrated into the list 800 to further assist the recommending of new products and/or services additionally, clicking any item within this list 800 will expand within the same window further details and the opening of exact invoices.

The images and icons 250 can be integrated into the list 800 by defining within the admin control panel 40 and calling on them through code. This is a simple upload image option from within admin control panel 40 that then allows the company to choose which products/services to associate said images with. There is then an option to show these said images within these lists.

In one embodiment, the right field 790 will list a fully comprehensive customer information 430, such as history, including date of customer account creation, purchase history, service changes and charges, store visits, and account and bill modifications. Both fields 790 and more addable fields are editable and fully configurable through the Admin Control Panel. Fields list all information in an organized, dynamic, list pattern. Furthermore as with the preceding selecting any item within the list will expand within the same window further details and the opening of exact invoices.

In one embodiment an icon 250 may look like bags and are to represent services and products or metrics that the company offers, the ‘bags’ are customizable to be anything from a cell phone to a lawnmower or vacuum cleaner or any custom image that the company desires. This image or icon 250 can be changed by defining within admin control panel 40 and calling on them through code. This is a simple upload image option from within admin control problem that then allows the company to choose which products/services to associate said images with. Additionally, the order in which these images appear may be defined within admin control panel 40.

The names can be displayed on the icons 250 or bags 250 and can be changed depending on which products and or services are available. The possibility of adding additional icons 250 or ‘bags’ or removing them may be available through the Admin Control Panel. The icons 250 or bags 250 may illuminate based upon the action performed, one selection will change to a yellow highlight and “service offered”, two selections a green light and “service sold”, three selections a red light and “service declined” four selections a white light and “not available.”

The point of sale module 810 may perform these functions automatically if the products are sold through the point of sale module 810. All of these options can be changed based upon the company's needs and desires by predefining all parameters 50 and settings 830 from within the point of sale module 810 of the administrator control panel 40. For example, if the company chooses to only permit the choosing of “offered” and “declined” and “sold” or “not available” to auto-select by the point of sale module 810, this option may be selected. The system will then obey this rule programmatically throughout the present invention 10, whether system-wide or location-specific.

Customer begins interaction with employee; and said employee will begin by entering metrics 710, such as customer name, phone number, and email address (or whichever metrics the company deems most relevant to their particular industry.) Some customer information 430, which may be referred to as “top fields, such as phone number, customer name, and/or email address will auto-populate the entire window and give search options in a secondary drop-down menu available by pressing an icon 250, such as the magnifying glass icon. This auto population is performed by the system, pulling information from existing company database(s), this is made possible by the system executing code that silently searches and retrieves customer information based upon the field 790 typed in. For example, the user or employee types customer phone number, either full or partial, the system does a search for said number and displays immediately the results found thus far, in a manner similar to a Google® search, in a drop down with pertaining information with partial or full results. If a partial or full result is selected from the drop down 880 menu, the system then retrieves from the pertinent customer database 20, displays, and populates all customer information in the program fields 790. This enables easy auto-completion for return customers. Obviously, this will not work for completely new customers that have not been to any company locations whatsoever. The data 20 must already exist within one of the company databases 90. It will exist after submission of the current customer if this is the case.

There may be large open lists-rows 890 one to the left, and one to the right which allow for the custom input of lists 800 by the user, who would normally be a corporate entity such as a company. The number of these can be changed based on the company's desires The lists-rows 890 are changed based on the company's desires The lists-rows 890 of data that may be selected and then show more information via a popup/window expansion within the present invention 10. For example, a left box displays row 1, row 2, and row 3, and so on of all owned and recommended products. Right box displays: row 1, row 2, row 3, and so on of all customer history (purchases, service changes, store visits, etc.), each new item taking one entire “line/row.” Activating or clicking one of these “rows or lines” will expand a window within the present invention 10, displaying full detail of the selected item.

For example, the left field 790 will change based on system populated ‘needs’ and currently owned products or subscribed services. This list 800 will dynamically change and will be fully configurable through the admin control panel 40. Images and icons 250 can be integrated into the list 800 to further assist the recommending of new products and/or services additionally, clicking any item within this list 800 will expand within the same window further details and the opening of exact invoices.

The images and icons 250 can be integrated into the list 800 by defining within admin control panel 40 and calling on them through code. This is a simple upload image option from within admin control panel 40 that then allows the company to choose which products or services to associate said images with. There is then an option to show these said images within these lists.

In one embodiment, the right field 790 will list fully comprehensive customer information 430, such as history, including date of customer account creation, purchase history, service changes and charges, store visits, and account and bill modifications. Both fields 790 and more addable fields are editable and fully configurable through the Admin Control Panel. Fields list all information in an organized, dynamic, list pattern. Furthermore, as with the preceding selecting any item within the list will expand within the same window further details and the opening of exact invoices.

In one embodiment an icon 250 may look like bags and are to represent services and products or metrics that the company offers, the ‘bags’ are customizable to be anything from a cell phone to a lawnmower or vacuum cleaner or any custom image that the company desires. This image or icon 250 can be changed by defining within the admin control panel 40 and calling on them through code. This is a simple upload image option from within admin control panel 40 that then allows the company to choose which products or services to associate said images with. Additionally, the order in which these images appear may be defined within admin control panel 40.

The names can be displayed on the icons 250 or bags 250 and can be changed depending on which products and or services are available. The possibility of adding additional icons 250 or ‘bags’ or removing them may be available through the Admin Control Panel. The icons 250 or bags 250 may illuminate based upon the action performed, one selection will change to a yellow highlight and “services offered”, two selections a green light and “service sold”, three selections a red light and “service declined” four selections a white light and “not available.”

The point of sale module 810 may perform these functions automatically if the products are sold through the point of sale module 810. All of these options can be changed based upon the company's needs and desires by Predefining all parameters and settings from within the Point of Sale module of the Administrator Control Panel. For example, if the company chooses to only permit the choosing of “offered” and “declined” and “sold” or “not available” to auto-select by the Point of Sale module, this option may be selected. The system will then obey this rule programmatically throughout the present invention 10, whether system-wide or location-specific.

Everything is fully customizable from the Admin Control Panel from the highlight colors and verbiage to the images of the ‘bags’ themselves. The “service sold” and “service not available” ‘bags’ and highlights will be automatically entered upon accessing an existing customer account, if said existing customer has already purchased a certain product, service, or metric and cannot be re-sold. If this is a new customer all the information will now be entered by the employee and after saving the data will be available through the database for all future interactions, created reports, and database accessing programs. If PSM has previously been purchased, but is again available, the database will allow the present invention 10 to indicate as such to the employee by returning the ‘bag’ to its original uncolored, unselected state to record anew this current customer interaction. The bags are essential to employee grading and will be included in many reports and employee assessment functions.

In one embodiment of the present invention 10, along the bottom of the a window may be icons 250 that represent customers 300 which can be toggled between by the employee or user if the user is handling more than one customer at a time. These can also be used to return to the customer part of the window once the optional point of sale system or point of sale module 810 has been accessed. The point of sale module 810 is optional for the company to replace their existing point of sale.

The customer's 300 first name will appear “printed” on their shirt icon 250 making access and memory a breeze for all employees. Next to the customer icons 250 may be a risk identifier 840 such as an orange flag, which changes from white, yellow, orange, and red based on the employee's assessed “risk” level of the current customer, whether that risk be a default on account payments or anything else the company may deem necessary.

Another icon 250 such as a “sticky note” appears to the right of the risk identifier and can be clicked, or pressed to open a selection list, as to whether this is going to be a reminder, memo, order, or follow-up. After selecting which kind of note the employee would like to create a larger text field 790 opens up and allows for the composing of a custom note by the employee. Finally, are the clear and submit buttons are available, if an error was made or if the customer decides to leave the location while this information is being filled out, the employee can clear the window. Once the employee has finished and everything is filled in the submit button can be pressed and the data and customer information are saved to the database, also, every time a new field is selected the data is saved, and should the window close for some unforeseen reason the data will automatically save, ready for the next time the present invention 10 is activated.

Everything in the present invention 10 and its windows are fully integrate-able to the company database 20 with full auto-completion of all information. The customer capture window 180 may always be open and running and is fully configurable through the admin control panel 40. Full import and export capability for reports, database compiling 850 and history viewing. Automation of said tasks is also available and can be performed on an interval schedule. The present invention is available cross-platform due to its secure web-based nature, and is always accessible via anything that is capable of running a web-browser. All actions and abilities of the present invention are permission based as set by the admin control panel 40. In the top right corner of the one of the windows or interface 500 may be information on the current user. The user may have an avatar or picture or icon 250 appear as well as the name of the user, their employee id, store location, or other pertinent information; all of which is dynamically imported from the admin and user control panels 310. If the user should change, clicking the avatar will log the current user out, and allow the switching and new login of a user through the username and password.

The present invention 10 may also have a point of sale module 810, which may be accessed simply by activating an icon 860, such as by pressing the orange cart button at the top of the screen or by scanning the barcode on an item using a barcode scanning gun or similar device. Once the item has been scanned or the button pressed the window will transform from the customer capture window 180 to the point of sale module 810 or point of sale window 810. If an item is scanned, it will automatically populate the SKU and/or item name into the field. This information can be set by the company through the point of sale module 810 or the administrator control panel 40

Add and remove buttons 870 are provided for the manual adding and removing of items to the list 800 if the scanner is not available. If the item or product cannot be found or if more information is desired, then the user can click a yellow magnifying glass. Click this button and a friendly drop down menu 880 will appear, listing items with the option to show little images or icons 250 of the items and listing their names, SKU, price, whatever the company would like to be in the drop down menu 880. This also allows for the editing of individual items and their prices, description, etc. on a bulk level. Other information such as tax exemptions can be added in here. All of this is customizable from the point of sale module 810.

In one embodiment the interface 500, may have, to the right of the item field 790, is the price, which will auto populate when the item is entered, based on prices set within the admin control panel 40, and thus retrieved from existing database 20 information, and the cost to the company the cost is simply for reference and obviously, cannot be edited and can only be seen if permissions allow, with the up (↑) and down (↓) buttons allowing for the changing of price by a dollar or percentage amount. Simply clicking the price text field will allow for the manual entry of prices if the permissions are set within the admin control panel 40. Past that in the same field lists 800, if the company desires the cost to the company will and can be shown.

Another field 790 to the right of the price field 790 is the quantity being purchased by the current customer and the quantity/stock available within the store, the same add and remove buttons 870 as are on the left-hand side are available in this field 790 allowing for the adding of more items to the customers' cart or the removing of quantities even down to zero, thus removing the item completely from the list 800. Alternatively, this can be manually entered by simply selecting the text field 790 and tying in a raw number. For example, the farthest right field may show the total price of each item after adjustments but before tax, allowing for a comprehensive breakdown of discounts and charges. When each of the items are scanned or entered their respective ‘bag’ icon 250 will also illuminate appropriately, green for sold, and white for non-applicable to the purchase, demonstrated item names are green because they are ‘sold’. In one embodiment there can be a large text field 790 allowing for the dynamic, comprehensive listing of similar items, a customer purchase history, renewal reminders, etc. This is simply carried over from the original window 500 or interface 500 for ease of accessibility and viewing, as mentioned previously this functions the same. To the right of the comprehensive item and customer list 800 is the essential total box. The box will list the subtotal, the combined value of any discounts applied, the tax, percentage changing depending on location, and the final or “grand total.”

All of this will dynamically change with the scanning or entering of items, adding of discounts, and changing of tax exemptions. The interface 500 can have icons having relative colors for quick and easy reference. The present invention 10 can pull all of the product information straight from the company database 20 and recording the transaction back to the database 20 systematically and simultaneously, nothing is saved permanently until the final submit button is selected until then everything in the transaction can be considered ‘suspended’.

Down at the bottom of this insert is the remaining total. Should a customer pay with cash and a card, or a check and a gift card, etc. any combination that is used it will list the new total dynamically, as a payment is entered activating an icon 860 or clicking the relevant icons 860 will allow for the selection for things such as Credit or Debit or Gift Card, a personal check, e-check, or traveler's check. To the far right of the window 500 or interface 500 are the payment buttons and fields, these allow for the typing and splitting of payments using several different forms of payment per transaction. The ability to charge to several cards or different cash payments is available to the user for simplicity. Further payment options can be added or removed via the point of sale module 810,

In one embodiment, the user may click or activate the advanced button. Activating this button or icon 860 may open up the full point of sale module 810 also referred to as a point of sale window 810 with all the advanced options, will fill the window and anything relevant to point of sale will be shown here. It can replaces the previously used condensed version of point of sale module 810, and any already entered information will be carried over to the new point of sale module 810 interaction display, this is done seamlessly, non-intrusively, and fluidly. This is performed by the system reading from all existing fields and utilizing this information within and throughout the point of sale module. Additionally, this information may be retrieved from existing database(s) in real-time and to ensure accuracy.

Within this advanced point of sale module 810 form, anything the company desires and deems relevant and pertinent to their specific point of sale module 810 can be contained, all of which is defined within the same or another module, and for example all of the information can be defined in the admin control panel 40.

The customer icons 250 at the bottom of the window 500, also referred to herein as interface 500, if activated, by, for example clicked or tapped, will allow for the returning to that specific customer's customer capture window 180 page within the window 500, and vice versa, alternatively a point of sale button can be clicked to the same end, and indicated with whom this transaction is taking place.

In one embodiment, there can be a notepad at the bottom of the window 500 or interface 500 allows for notes and the like. If the user activates an icon 860 a bottom cube will expand into a text field 790, with four buttons, one for memo, reminder, follow-up, and order. Clicking one of these smaller buttons will allow for the entering and saving of a note for this specific transaction, saved to the database 20 under the individual customer with whom the transaction is taking place. A timestamp will be available for adding and when activated or clicked will expand a small calendar allowing for the precise selection of time and date. All of the information is being saved to the database 20 every time a new field 790 is selected or a button pressed, organized under the specific customer with whom the transaction is taking place.

Upon finishing the transaction, the submit button is activated or pressed, the payment is processed, customer entered into database, products removed from inventory, and receipt/and report are compiled. The customer icon at the bottom of the window 500 pertaining to this specific transaction and customer will now blank, will lose all glow-effects, and become a unisex blob, as the customer and their transaction have now been saved to the database 20, allowing for future referencing by anyone who has been granted access to that information via the admin control panel 40.

If some unforeseen circumstance requires that the entire process be aborted, the clear button is always available, it will literally clear all fields and clear the customer icon from the bottom of the page 500 or window 500. Bringing the user back to the beginning with a blank slate 500, or blank page 500, also referred to as a blank window 500.

Within the admin control panel 40 is the ability to add and remove or change every single facet and function of the present invention 10. Primarily before any parameters, settings, or functions are changed the initial database 20 importing must occur. The company or owner of the program 10, also referred to as a system or present invention 10, may be presented on screen with an option to browse the interface 500. There are a multitude of options as to databases 20 they may select, customers, employees, products/services, and banking/accounting. Upon activating or clicking the relevant browse button for the desired subject, ex. Customers, the ability to physically browse for and select said database 20 file is presented, this physical file may be located on the current computer, or the company network, whether local or internet based, upon successful selection of said database 20 file, the user is prompted with two options “is this a one-time or recurring import of data?” If recurring is selected, the user will enter the interval at which this database 20 file is to be continually and automatically imported by the present invention 10. User desires the customer file to continually be imported into the program of the present invention 10 every fifteen minutes of every day, the user would type “00:15” and then daily from the drop-down menu 880. Upon successful selections of this database 20 file (ex. Customers) the program of the present invention 10 will import, read from, and save this information for use throughout program of the present invention 10, by all modules 60 and the window 500 or interface 500.

This identical process should be done for every relevant item the company wished to tap into or use throughout the program of the present invention 10ex. products, employees, or accounting. The user will also, when choosing when to read from the database 20, be prompted with the option to write to the database 20, this also may be set on a one-time or interval schedule and is useful for companies wishing to use program of the present invention 10 in conjunction with other existing programs such as an external point of sale; this however is not required as the program of the present invention 10 is capable of replacing any existing software on its own through the use and implementation of modules 60.

These said processes are a one-time setup through the admin control panel 40, and may be performed from one instance of the admin control panel 40. All information saved by program 10 can be saved into the company's own or a worldwide cloud platform ex. Google Drive, of which the login and relevant details may be defined at this time. The aforementioned automated functions of importing and exporting (or reading and writing) of these database 20 files creates the bridge of enabling the program 10 to read all existing company data 90 and in addition save to the company databases 20 and allows other programs as mentioned before to have all current data available to them for usage of, as prior to the existence of the program 10, this once again allows the program of the present invention 10 to co-exist with any and all existing software if a company so desires and opts to not use the program of the present invention 10 as the sole company business solution.

In one embodiment of the present invention 10, the browsing of imported and exported data is simplified by a simple browse menu, choose the data 90 desired, how often, from where, and in which format.

Beginning with the global module 370, an administrator can change entire functions across the entire system through this tab, from the ability to create automated tasks such as reports and grading pulled directly from the company's existing databases that have also been augmented by the program of the present invention 10. Employee grading can also be set up from here, which will be discussed later. Changing the appearance and feel of the entire system is available through this global module 370, themes and colors, as well as text, verbiage, and report types.

The present invention 10 may also have a user's or location module 60 that can be used to set the access capabilities of certain users and sets of users or groups. This also makes adding new users and new groups simple with the click of a button and filling in all of the relevant information. This allows for the creation of rewards systems and automated employee feedback, new users, locations, and rules for said users and locations. Finally, allows for the full automation of employee grading and reports management, set on individual, local, regional, or company-wide levels. Setting the automatic creation of these reports 80 is as simple as creating the automatic importing and exporting of data 90, simple prompting of which/what information is desired, how often, and from which databases 20 the information is pulled.

The largest and one of the most important modules 60, may be the customer's module. This module 60 allows the administrator to set per-user and per-group permissions giving exact parameters 50 to what kind of access each user has to data 90 from the database 20. Allows for editing of what information is required to be collected from the customer. Also allows the setting of how this information is entered into the database 20. Enables the setting up of automatic customer follow-up and the execution of said functions.

Another module 60 may be the products module 60, which may allow for the adding and removing of products and the defining of their parameters 50 such as price, quantity, and any other promotions or information attached to the product. This module 60 allows for the automation of sending or receiving of data 90 about products and the sale of them to/from the database 20. Additionally, price comparisons may be entered here from other companies. The present invention 10 may also have a module 60 called a marketing module 60, which allows for the automated creation and custom creation of marketing templates and marketing tactics. This module 60 defines who can and cannot create and send marketing data. This marketing data can be email, mailers, phone prompts, etc. is distributed throughout the company on a permission basis and customized schedule defined by the company or owner, or one in possession and control of the present invention 10. Reports 80 ensure quality and they keep a company running smoothly, the program of the present invention 10 allows for managers to spend less time writing and compiling these reports 80 and more time with their employees and customers. Reports 80 can be anything the company desires, sales, employee tracking, customer trends, product trends, anything. Reports 80 can be automated from here, sent out every fifteen minutes if the company desires (or longer), and through this module 60 the people who receive them can be defined. The format and means of how the reports 80 are sent is also changeable through this module 60, reports 80 can be automatically emailed, automatically printed, automatically texted, or anything else the company can contemplate. This is performed by initial setup and defining of said reports via and within the administrator control panel, reports module. Code is written for this purpose to allow infinite execution and customization of reports.

Every parameter of the reports 80, from the information contained within, the ability of certain users to be able to see the reports 80 and how often they are compiled. The program of the present invention 10 can be set up from here to read and write from any database 20 it is given access to pertaining to reports.

Rewards is an optional but another function of the program of the present invention. Rewards 890 allows for the rewarding of employees. Based on sales achievements or customer interaction feedback, surveys, or comments, or capture rates, anything else the company would like to reward the employees for, or just to say, “You're doing a great job, keep up the good work!” These rewards can be as simple as a thank-you card, or as complex as more time off, or gift cards, whatever the company can imagine and desires. All of these can be edited, set, and automated through this module 60 as per-user, and per-group/location rules and limitations. A reminder that this module 60 and all other modules are optional and based upon the company's needs and desires.

Three custom module 60 tabs can be provided, but the amount can vary based again upon the company's needs and desires, there is an infinite expandability upon what is available. To edit how many tabs and modules exist simply activate or hit the add (+) button, or the remove (−) button 870 to add them and the custom creation will begin, however the company sees fit for that to proceed, whether it be a basic template or a whole, fully configurable interface. Such as, the ability to create, submits, manage, and receive purchase orders for new items.

The admin control panel 40 may be referred to as the mind of the present invention 10. The admin control panel is where everything can be set, parameters, look and feel, permissions, and even how the present invention integrates or replaces entire company systems. Using the buttons at the top of the interface 500, the printer, email, folders, and infinity symbol, one can set the automation of sending, receiving, importing, exporting, and printing of everything.

In the user control panel window 310, specific user settings can be changed. All initially set by the admin control panel 40 including, what can be and how it can be changed. Beginning with general settings like user info, store, location name, etc. The date and time format, as well as language and font settings, for an international clientele. Individual users can even be allowed to change their theme and colors for the entire system 10. However, the allowances here are unlimited and can be set and changed by the admin control panel 40 at any time. Report 80 settings can be changed based on user permissions and can change the format, information included, and anything else the company can desire to be included in editable reports 80. Customer interaction and experience reports 80 can be set up here, and the product/service/metric reviews and parameters 50 are editable here.

Through the customer capture window 180, the contact lists for the current users can be generated, these lists can contain anything, including, but not limited to, the name, phone number, address, visit history, account number, email address, and anything else the company desires and allows through the admin control panel 40. It also allows for the custom adding and removing, merging and organizing of existing customers who are pertinent to the current user. The accessibility of each of these features through this panel is controllable through the admin control panel. Rewards 890 is an optional module 60 should the company desire it, this module allows for the tracking and grading of individual employees and can show their ranking among their fellow employees if desired.

Though the most powerful tool of this rewards module 60 is the actual rewarding of individual employees, whether this again be time off, a bonus, or a gift card . . . anything the company desires or can imagine. The custom modules 60 again allow for whatever the company could desire be added, whether it be more personal modules, or more customer modules, or a forums module, this is all creatable through the admin control panel

Within the customer capture window 180, or a window 500, interface 500, or module 60 is everything that a company could do, digitally, with customers and their information. There may be a contact list module that allows for the creation of an all-purpose digital customer list defined per-user and per-group. The module 60 shows pending contacts with their phone number, reason for visiting, etc.

Through the customer capture window 180, all customer interactions, and contact attempts can be tracked and added to the employee grading system should the company desire this ability. Service reminders can also easily be auto or manually generated, and automatically or manually be sent out to customers on a per-user or per-group basis and as needed or deemed necessary by the company. These service reminders can be anything the company needs to communicate to the customer, ex. new subscription updates, recalls, insurance/warranty renewals, anything pertaining to getting the customer back into the store. Executes, and automates marketing, and sales opportunity reminders.

The personal module 60 will list the current users' personal customers who they have personally ‘captured’ or contacted, through here the user will be able to see organized dynamic lists of their customers and the notes, reminders, memos, tasks, etc. that have been attached to each customer. The employee or user will be able to see what, when, and where each customer purchased and/or was captured if their permissions allow. This module 60 will also allow for the execution of personal customer based follow-ups, reminders, and tasks; and dynamic customer information recalling.

There may be another module 60 called a location module 60 that does many similar functions as the personal module, simply on a broader, area-based scale. This location module 60 will list all of the customers for a given area and allow for the compilation of pertinent information as such. Finally, the company module 60 will do the same as the prior two but as the name states, company-wide, though a company probably would not want an entry-level employee to be able to access this panel, so permissions defining this would be set in the admin control panel 40. The custom modules 60 can be created through the admin control panel and can be anything the company could desire, fully integrate able with the program of the present invention 10 and existing databases 20 and company systems, and are exactly like all the other custom modules 60. Ex. a module 60 to allow for a support system such as a live chat or message board system if the company desires.

The program of the present invention 10 takes the raw data from the databases 20, and converting it into beautiful, useful, and essential reports 80. These reports 80 can be auto generated as often as the company likes, every five seconds if desired, or they can be manually created, selected from individual items, and compiled into any format desired. The whole idea is to have it automated though, the program of the present invention 10, can pull information automatically from existing company databases 20 and new databases 20, even as information is entered, and compile it into absolutely any format the company can think of, spreadsheets, graphs, text documents, etc. This system 10 is meant to be able to send these reports 80 not just by the usual boring email but can also send texts, automatically print, fax, and save reports 80 for later viewing. These reports 80 can be viewed on a phone, tablet, desktop, laptop, and television, anything that can run a web-browser, the beauty of cross-platform.

The reports 80 are pulled from company databases so, can contain any information that is included therein, employee statistics such as, sales numbers, punch-in and out, and reviews; customer information such as, follow up rates, review and return rates, purchase histories, and spending trends, even company-wide things such as product information, sales trends of products, product popularity by region, location, etc. and individual employee product sales.

These reports 80 can be used to grade the employees, stores, and regions based on performance. (A+ through F/1-100) The grading reports 80 can be tracked directly from the system 10 because of its ability to integrate with and write to and read from the company's existing databases 20. The way in which the present invention 10 does all of this work, the reading, writing, compiling, is all mandated by the admin control panel 40 under the reports module 60, since the system 10 is instantly writing to the database 20 and pulling product, customer, and employee information simultaneously the reports regarding those things can also be created instantly and simultaneously.

The company module inside the module called reports 80 allows for the creation and customization of reports 80 pertaining to the company itself. The admin control panel 40 allows for the regulation of who can see this module 60 and what they can see within it. Locations does a very similar function to the company module 60, simply changing the subject of focus from the entire company as a whole to the location or multiple locations at a time, simplifying the process but auto generating these reports and allowing for the full customization by the admin control panel as to who can access this module 60 and then within the module 60 of “location” itself the other settings such as the information contained within can be edited and chosen from.

Employee reports 80 will be the most useful module 60 for individual employee grading, being able to instantly track employee performance and grade them as well, from their sales numbers and capture rate to their reviews and their over-time performance, given the ability to track deep into the employees' history through the databases; being able to directly compare to other employees.

Customer reports 60 can be generated and reviewed, created and edited from the Customers module 60 within the Reports module 60 tab, the tracking and capture of customers can be compiled into beautiful reports 80 for the company to see in any format they see fit, and on any technology with the ability to run a web-browser. Customers can be tracked by purchase history, area, return rate, spending anything the company can desire. A lot of the information pertaining to customers and their stored information were discussed in the captured customer's window 180, also referred to as the customer capture window 180. The customer capture window 180 allows for the recommending of products to customers based upon similar customers' purchase history, and gives the company the opportunity to determine which products are going to be the “big sellers” and which ones are going to need a little more “finesse” with the selling process.

Products runs similar to the customer module 60 as it is tracking sales, customer histories, stocking, replenishment, and organization. These reports 80 can show everything from average sale price of an item, to the cost to produce/sell the item. Comprehensive, in-depth, dynamic reports 80; exactly what a company wanting to thrive in the modern era needs. Through optionally implemented purchase module 60 via admin control panel 40 product report data may be used to auto generate and submission of re-ordering and stocking of products.

In a settings module 60 the user can edit their personal reports compilation settings, such as the format, frequency, and subject contained within. Do they want a report 80 showing customers, employees, and products, sorted by location? This can be the place to do it. Simply select the options as to who, what, where, and when you want this information from and about. One could even change the font and color of reports 80 in this section.

Lastly, custom reports 80. The reports that the present invention 10 can create and automate are infinite; literally, absolutely anything the user could ever want in a report 80. The present invention 10 can create and automate by just the simple click of a button. All that is required by the user is the selection and defining of any parameter(s), which they wish to compare to other parameter(s), anything pulled from the database can be compared, contrasted, compiled, and listed in any format at any time for any reason.

It can replaces the previously used condensed version of point of sale module 810, and any already entered information will be carried over to the new point of sale module 810 interaction display, this is done seamlessly, non-intrusively, and fluidly. This is performed by the system reading from all existing fields and utilizing this information within and throughout the point of sale module. Additionally, this information may be retrieved from existing database(s) in real-time and to ensure accuracy.

Reports 80 can be automated from here, sent out every fifteen minutes if the company desires (or longer), and through this module 60 the people who receive them can be defined. The format and means of how the reports 80 are sent is also changeable through this module 60, reports 80 can be automatically emailed, automatically printed, automatically texted, or anything else the company can contemplate. This is performed by initial setup and defining of said reports via and within the administrator control panel, reports module. Code is written for this purpose to allow infinite execution and customization of reports.

If the user wants to create a module 60, the user may first create a file 960 module 60, such as file module1.php. In this module 60 the user defines the database 20 parameters 50. This can be performed in Notepad if using Windows, or Text Edit if using a MAC.

I claim:

1. A unified digitization of company essentials with remote accessibility system (10), comprising:
a module (60);
said module (60) operable with a database (20) having customer information (430) and store information (440).

2. The system (10) of claim 1, wherein said module (60) is customizable.

3. The system (10) of claim 1, wherein said module (60) is operable with said database (20) by a set of parameters (50) that are defined from within an administrator control panel (40) of the system (10);
said parameters (50) allow the system (10) to read from and write to said database (20).

4. The system (10) of claim 1, whereby there are a plurality of said modules (60), and said modules (60) can be selected to launch a certain portal (140) including at least one of the following; an admin control panel (40), user control panel (310), reports and trends window (450), customer capture window (180), and a customer interaction window (240).

5. The system (10) of claim 1, wherein the system (10) is a website.

6. The system (10) of claim 1, wherein the system (10) is a computer program.

7. The system (10) of claim 1, wherein the system (10) is a web application.

8. The system (10) of claim 1, wherein said module (60) prompts a user to ask a customer a series of questions.

9. The system (10) of claim 1, further comprising a module (60) that launches a window (500) that prompts the user to qualify a client or customer information; said window has an icons (250), have different colors as indicators as to whether the user is supposed to offer a specific good or service to the customer.

10. A method of using a unified digitization of company essentials with remote accessibility interface, comprising the steps:
logging in (600); and
selecting a module (700) that has been operably connected to a database; and
displaying information (940) obtained from said database on a window (500).

11. The method of claim 9, wherein said module is at least one or more of either a global module (370), a user and location module (380), a customer module (240); a marketing module (410), a product module (400); or a report module (420).

12. The method of claim 10, wherein the method of selecting a module (700) is preceded by the step of opening a window (960).

13. The method of claim 11, wherein said window is an admin control window (40).

14. The method of claim 9, further comprising the step of alerting a salesperson (950).

15. A unified digitization of company essentials with remote accessibility system (10), comprising:
a plurality of modules (60);
said module (60) operable with a database (20) having customer information (430);
said module (60) is customizable and said module (60) is operable with said database (20) by a set of parameters (50) that are defined from within an administrator control panel (40) of the system (10);
said parameters (50) allow the system (10) to read from and write to said database (20);
said modules (60) can be selected to launch a certain portal (140) including at least one of the following; and admin control panel (40), user control panel 310, reports and trends window 450, customer capture window (180), and a customer interaction window 240; and
at least one of said modules (60) that launches a window that prompts the user to qualify a client or customer information; said window has an icons (250), have different colors as indicators as to whether the user is supposed to offer a specific good or service to the customer.

15. A method of using a unified digitization of company essentials with remote accessibility system (10), comprising the steps of:
creating a file (970):
creating a module (920);
linking said module to a database (910).

16. The method of claim 15, further comprising the steps of:
creating a file (970) includes the step of defining parameters (900).

17. The method of claim 15, further comprising the steps of:
creating at least one more module (920) that is operably linked with at least one of either the same database or a different database (910).

18. The method of claim 15, whereby said database (910) contains at least one or more of the following, customer information (430), or store information (440).

19. The system (10) of claim 7 further comprising the step of making all changes instantly live (980) because the system (10) being designed and developed using collective web languages.

20. The system (10) of claim 1, comprising the step of programming the system for unlimited capabilities of use (990), which is performed by the step of enabling the addition, modification, and removal of any and all modules molding and fulfilling the desired functions and requirements of any and all companies and fields (1000).

21. The system (10) of claim 8, further comprising an editing feature in said module (60) to edit any module (60) by accessing the module (60) directly or from within the administrator control panel (40) parameters (50) may be written, defined, and set and a then saved to a database (20), structuring and defining said module (60).

22. A method of making a unified digitization of company essentials with remote accessibility (1000), comprising the steps of:
making a module (60) that can display customer information (1010);
entering metrics (1020), such as customer name, phone number, and email address, or whichever metrics the company deems most relevant to their particular industry; some customer information (430), called “top fields, such as phone number, customer name, and/or email address will auto-populate the entire window and give search options in a secondary drop-down menu available by pressing an icon (250), such as a magnifying glass icon;
auto-populating (1030) performed by the system pulling information from existing company databases made possible by the system executing code that searches and retrieves customer information based upon the field typed in, for example, the user or employee types customer phone number, either full or partial, the system does a search for said number and displays immediately the results found thus far, in a manner similar to a Google® search, in a drop down with pertaining information with partial or full results; If a partial or full result is selected from the drop down menu the system then retrieves from the pertinent customer database, displays, and populates all customer information in the program fields 790; this enables easy auto-completion for return customers; obviously, this will not work for completely new customers that have not been to any company locations whatsoever; the data 90 must already exist within one of the company databases; It will exist after submission of the current customer if this is the case;
recording (1040) of whether permission has been given to use the telephone as a valid means of contacting the individual customer on the current account; and recording of the address as well as for the tracking of most popular areas, and for the mailing of packages, mailers; another icon, may allow for integration with any map engine to show the exact street location of the customer's residence or place of business;
integrating the map ((1050) by defining parameters (900) within the administrator control panel (40); this is done by providing a pre-defined link (820) such as a link to Google Maps®, or similarly predefined link (820) that is ready for the insertion of an address, such as a customer (300) address; the system executes code upon retrieving customer address that converts an icon 250, such as the globe icon, into this predefined digital map link, containing the customer address. When this predefined map link (820) with customers address is selected, a digital map will appear, pinpointing the customers address; this is all performed and executed via written code;
creating custom fields (1060) through the admin control panel (40); said admin control panel (40) may allow the user to add or remove custom fields by clicking or activating the add (+) and remove (−) buttons located next to the custom fields;
selecting a visit summary field (1070), which will, once selected, expand to a larger text field allowing for the custom entry of a summary of the visit including whatever has been deemed essential by the company. Upon submission of the current customer interaction, the visit summary along with all other fields 790 and information will be compiled and available for distribution within the company;
expanding the visit summary (1080) by an allowance in the code for the text box to auto-expand or auto-resize when the text entered exceeds the current view; for example, one line becomes two, two becomes three, three becomes four, etc. . . . and this can occur up to a predefined amount and size defined within the admin control panel 940);
compiling (1090) is performed by, the system (10) writing all collected data (90) to all pertinent databases (20) of the company, which makes this data (90) and all changes reflect immediately company-wide; all database parameters (50), such as location of, are defined in the admin control panel (40); for example, upon submission of the current customer, all customer data (90) will submit and save-to the existing company “customer information” database, which is selected within admin control pane (40) prior to the present invention (10) running in a company;
populating by the system (1100), pulling information from existing company database(s), this is made possible by the system executing code that searches and retrieves customer information based upon the field (790) typed in; for example, the user or employee types customer phone number, either full or partial, the system does a search for said number and displays immediately the results found thus far, in a manner similar to a Google® search, in a drop down with pertaining information with partial or full results; If a partial or full result is selected from the drop (880) menu, the system then retrieves from the pertinent customer database (20), displays, and populates all customer information in the program fields (790); this enables easy auto-completion for return customers; obviously, this will not work for completely new customers that have not been to any company locations whatsoever; the data 20 must already exist within one of the company databases (90); It will exist after submission of the current customer if this is the case;
integrating the present invention to the company database (1110) with full auto-completion of all information; the customer capture window (180) may always be open and running and is fully configurable through the admin control panel (40); full import and export capability for reports, database compiling 850 and history viewing; automation of said tasks is also available and can be performed on an interval schedule; the present invention is available cross-platform due to its secure web-based nature, and is always accessible via anything that is capable of running a web-browser; all actions and abilities of the present invention are permission based as set by the admin control panel (40); in the top right corner of the one of the windows or interface (500) may be information on the current user; the user may have an avatar or picture or icon (250) appear as well as the name of the user, their employee id, store location, or other pertinent information; all of which is dynamically imported from the admin and user control panels (310); and
activating at least one of either a button or icon to open up the full point of sale module (1120) also referred to as a point of sale window (810) with all the advanced options, will fill the window and anything relevant to point of sale will be shown here; said point of sale module (810) It can replaces the previously used condensed version of point of sale module (810), and any already entered information will be carried over to the new point of sale module (810) interaction display, this is done seamlessly, non-intrusively, and fluidly; this is performed by the system reading from all existing fields and utilizing this information within and throughout the point of sale module; additionally, this information may be retrieved from existing database(s) in real-time and to ensure accuracy.
